(19) United States
(12) Patent Application Publication
(10) Pub. No.: US 2025/0068583 A1
(43) Pub. Date: Feb. 27, 2025

(54) NETWORK-ON-CHIP ARCHITECTURE WITH DESTINATION VIRTUALIZATION

(71) Applicant: XILINX, INC., San Jose, CA (US)

(72) Inventors: Krishnan SRINIVASAN, San Jose, CA (US); Ygal ARBEL, Morgan Hill, CA (US)

(21) Appl. No.: 18/238,369

(22) Filed: Aug. 25, 2023

(51) Int. Cl. G06F 15/78

(52) U.S. Cl. CPC G06F 15/7825

(57) ABSTRACT

Embodiments herein describe using virtual destinations to route packets through a NoC. In one embodiment, instead of decoding an address into a target destination ID of the NoC, an ingress logic block assigns packets for multiple different targets the same virtual destination ID. For example, these targets may be in the same segment or location of the NoC. Thus, instead of the ingress logic block having to store entries in a lookup-table for each target, it can have a single entry for the virtual destination ID. The packets for the targets are then routed using the virtual destination ID to a decoder switch in the NoC. This decoder switch can then use the address in the packet (which is different than the destination ID) to select the appropriate target destination ID.

### TECHNICAL FIELD

Examples of the present disclosure generally relate to using virtual destination identifiers (IDs) to at least partially route packets through a network on chip (NoC).

### BACKGROUND

A system on chip (SoC) (e.g., a field programmable gate array (FPGA), a programmable logic device (PLD), or an application specific integrated circuit (ASIC)) can contain a packet network structure known as a network on a chip (NoC) to route data packets between logic blocks in the SoC—e.g., programmable logic blocks, processors, memory, and the like.

The NoC can include ingress logic blocks (e.g., masters) that execute read or write requests to egress logic blocks (e.g., servants). An initiator (e.g., circuitry that relies on an ingress logic block to communicate using the NoC) may transmit data to many different destinations using the NoC. This means the switches in the NoC have to store routing information to route data from the ingress logic block to all the different destinations, which increases the overhead of the NoC. For example, each target has a destination-ID where each switch looks up the destination-ID and routes the transaction to the next switch. To this end, a switch consists of a lookup-table. The size of the lookup-table is limited due to both area and timing considerations. For example, in one embodiment, a switch can route up-to 82 destinations. However, increasingly, there are more targets than an initiator can access. For example, a system with 4 high bandwidth memory (HBM)-3 stacks exposes 128 targets that each initiator is required to access.

To increase the number of targets that an initiator can access, one solution is to increase the number of entries in the lookup-tables. This has direct implication on the size of the NoC switches and the timing of the switches. Further, this limits the scalability of the design. As more devices are put together in a scale-up methodology, the NoC needs to be redesigned to account for more targets.

### SUMMARY

One embodiment described herein is an IC that includes an initiator comprising circuitry and a NoC configured to receive data from the initiator to be transmitted to a target. The NoC includes an ingress logic block configured to assign a first virtual destination ID to the data, wherein the first virtual destination ID corresponds to a first decoder switch in the NoC and a first NoC switch configured to route the data using the first virtual destination ID to the first decoder switch. Moreover, the first decoder switch is configured to decode an address in the data to assign a target destination ID corresponding to the target.

One embodiment described herein is a method that includes receiving, at a NoC, data from an initiator, decoding an address associated with the data to generate a first virtual destination ID corresponding to a first decoder switch in the NoC, routing the data through at a portion of the NoC using the first virtual destination ID to reach the first decoder switch, determining a target destination ID at the first decoder switch corresponding to a target of the data, and routing the data through a remaining portion of the NoC using the target destination ID.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 is a block diagram of a SoC containing a NoC, according to an example.

FIG. 2 is a block diagram of a NoC with a shared decoder, according to an example.

FIG. 3 is a block diagram of a NoC with a decoder switch, according to an example.

FIG. 4 is a block diagram of a NoC with multiple decoder switches, according to an example.

FIG. 5 is a block diagram of a NoC with multiple decoder switches, according to an example.

FIG. 6 is a block diagram of a NoC illustrating different segments, according to an example.

FIG. 7 is a block diagram of a NoC illustrating different segments, according to an example.

FIG. 8 is a flowchart for routing packets in a NoC using virtual destination IDs, according to an example.

FIG. 9 illustrates mapping system addresses to physical addresses in decoder switches, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe using virtual destinations to route packets through a NoC. In one embodiment, instead of decoding an address into a target destination ID of the NoC, an ingress logic block assigns packets for multiple different targets the same virtual destination ID. For example, these targets may be in the same segment or location of the NoC. Thus, instead of the ingress logic block having to store entries in a lookup-table for each target, it can only have a single entry for the virtual destination ID.

The packets for the targets are then routed using the virtual destination ID to a decoder switch in the NoC. This decoder switch can use the address in the packet (which is different than the destination ID) to select the appropriate target destination ID. Advantageously, the decoder switch can store only the information for decoding addresses for targets in its segment of the NoC, thereby saving memory. The packets are then routed the rest of the way to the targets using the target destination IDs. In this manner, the switches do not have to store the routing information for every target of an imitator, but only the virtual destination IDs of the segments that include those targets. For example, if an initiator transmits packets to 20 target destinations, which are in five different segments, instead of storing the destination IDs of each of the 20 target destinations, a switch coupled to the imitator only has to store virtual destination IDs for the five decoder switches that grant access those five segments of the NoC.

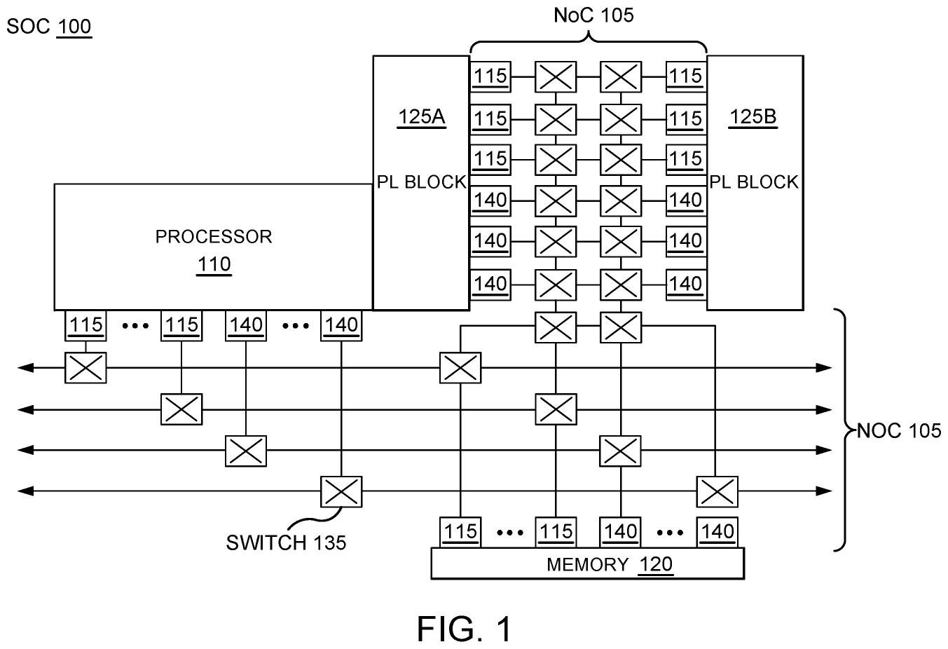

FIG. 1 is a block diagram of the SoC 100 containing a NoC 105, according to an example. In one embodiment, the SoC 100 is implemented using a single IC. In one embodiment, the SoC 100 includes a mix of hardened and programmable logic. For example, the NoC 105 may be formed using hardened circuitry rather than programmable circuitry so that its footprint in the SoC 100 is reduced.

As shown, the NoC 105 interconnects a programmable logic (PL) block 125A, a PL block 125B, a processor 110, and a memory 120. That is, the NoC 105 can be used in the SoC 100 to permit different hardened and programmable circuitry elements in the SoC 100 to communicate. For example, the PL block 125A may use one ingress logic block 115 (also referred to as a NoC Master Unit (NMU)) to communicate with the PL block 125B and another ingress logic block 115 to communicate with the processor 110. However, in another embodiment, the PL block 125A may use the same ingress logic block 115 to communicate with both the PL block 125B and the processor 110 (assuming the endpoints use the same communication protocol). The PL block 125A can transmit the data to the respective egress logic blocks 140 (also referred to as NoC Slave Units or NoC Servant Units (NSU)) for the PL block 125B and the processor 110 which can determine whether the data is intended for them based on an address (if using a memory mapped protocol) or a destination ID (if using a streaming protocol).

The PL block 125A may include an egress logic blocks 140 for receiving data transmitted by the PL block 125B and the processor 110. In one embodiment, the hardware logic blocks (or hardware logic circuits) are able to communicate with all the other hardware logic blocks that are also connected to the NoC 105, but in other embodiments, the hardware logic blocks may communicate with only a sub-portion of the other hardware logic blocks connected to the NoC 105. For example, the memory 120 may be able to communicate with the PL block 125A but not with the PL block 125B.

As described above, the ingress and egress logic blocks 115, 140 may all use the same communication protocol to communicate with the PL blocks 125, the processor 110, and the memory 120, or can use different communication protocols. For example, the PL block 125A may use a memory mapped protocol to communicate with the PL block 125B while the processor 110 uses a streaming protocol to communicate with the memory 120. In one embodiment, the NoC 105 can support multiple protocols.

In one embodiment, the SoC 100 is an FPGA which configures the PL blocks 125 according to a user design. That is, in this example, the FPGA includes both programmable and hardened logic blocks. However, in other embodiments, the SoC 100 may be an ASIC that includes only hardened logic blocks. That is, the SoC 100 may not include the PL blocks 125. Even though in that example the logic blocks are non-programmable, the NoC 105 may still be programmable so that the hardened logic blocks—e.g., the processor 110 and the memory 120 can switch between different communication protocols, change data widths at the interface, or adjust the frequency.

In addition, FIG. 1 illustrates the connections and various switches 135 (labeled as boxes with “X”) used by the NoC 105 to route packets between the ingress and egress logic blocks 115 and 140.

The locations of the PL blocks 125, the processor 110, and the memory 120 in the physical layout of the SoC 100 are just one example of arranging these hardware elements. Further, the SoC 100 can include more hardware elements than shown. For instance, the SoC 100 may include additional PL blocks, processors, and memory that are disposed at different locations on the SoC 100. Further, the SoC 100 can include other hardware elements such as I/O modules and a memory controller which may, or may not, be coupled to the NoC 105 using respective ingress and egress logic blocks 115 and 140. For example, the I/O modules may be disposed around a periphery of the SoC 100.

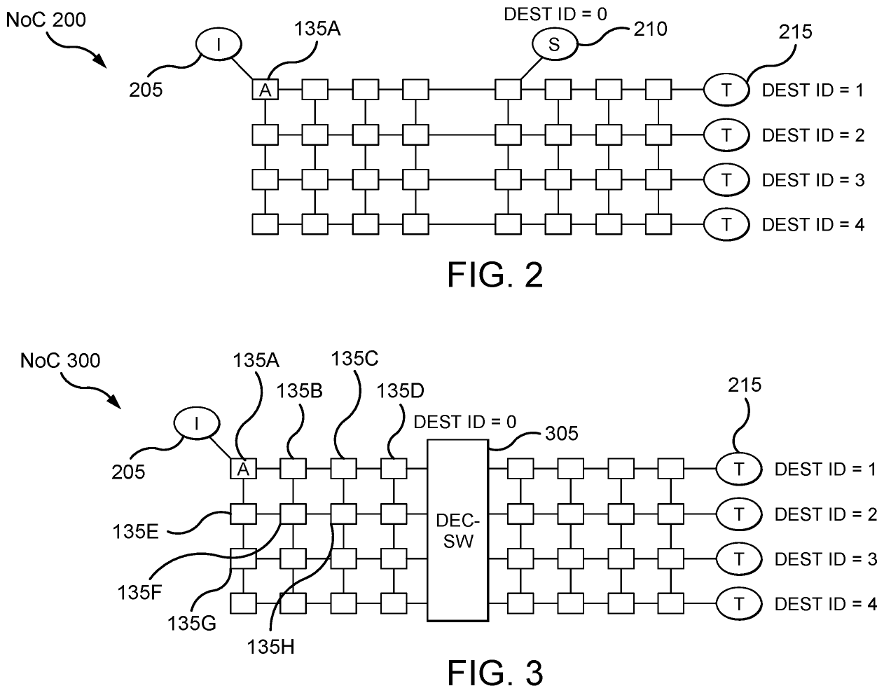

FIG. 2 is a block diagram of a NoC 200 with a shared decoder, according to an example. FIG. 2 illustrates another solution (rather than simply increasing the size of the routing tables in the switches) to increase the number of targets that an initiator 205 can access. In this approach, the NoC 200 includes a shared decoder 210 where all transactions are routed to. That is, when an initiator 205 (e.g., circuitry coupled to the NoC 200 such as the processor 110. PL block 125, or memory 120 in FIG. 1) wants to send a packet to one of the targets 215, the initiator 205 first sends the packet to the shared decoder 210. For example, when the initiator 205 wants to send a packet to any one of the targets 215 (which each have their own destination ID), the initiator 205 first assigns the destination ID for the shared decoder 210 (i.e., destination ID 0). Thus, the switches 135 between the initiator 205 and the shared decoder 210 only have to have routing information for transferring packets to the shared decoder 210, and not to the targets 215, thereby saving memory on those switches 135.

Once the shared decoder 210 receives the packet, it can use an address in the packet to then identify the correct target 215 and then re-insert the packet back into the NoC 200 with the destination ID corresponding to the target (e.g., destination ID 1-4). In this example, any request to destination IDs 1, 2, 3 or 4 are first routed to shared decoder 210 (Dest-ID 0). The shared decoder 210 performs its own decoding and re-routes the transactions to the correct destination.

However, there are several issues with this virtualization approach. First, it introduces extra latency for the time that a packet is moved out of the NoC 200, decoded by the shared decoder 210, and then re-inserted into the NoC 200. Second, the shared decoder 210 can take up a significant amount of area on the SoC. Third, it can create a bottleneck at the shared decoder 210. While FIG. 2 shows just one initiator 205 that relies on the shared decoder 210 to perform virtualization, the NoC 200 may include many initiators that rely on the same shared decoder 210, which can overwhelm the decoder 210 (or result in having to add more shared decoders 210 which further increases the amount of area needed).

Thus, the embodiments below discuss other techniques for virtualizing destination IDs without using a shared decoder. These techniques can increase the number of targets that an initiator can access while improving latency and bottlenecks relative to the embodiment shown in FIG. 2.

FIG. 3 is a block diagram of a NoC 300 with a decoder switch 305, according to an example. The NoC 300 has a combination of NoC switches 135 and address decode enabled switches (referred to as decoder switches 305). The decoder switches 305 have an address decoder in the switch which allows the NoC 300 to reduce the number of targets by permitting the decoder switch 305 to perform a second level decode (e.g., convert a virtual destination ID to a target destination ID).

In FIG. 3, when the initiator 205 wants to send traffic to one of the targets, an ingress logic block (e.g., an ingress logic block 115 in FIG. 1) first assigns a virtual destination ID that corresponds to the decoder switch 305. In one embodiment, the ingress logic block may map an address range (or ranges) corresponding to the four targets 215 in the NoC 300 to the same virtual destination ID (i.e., destination ID 0). Put differently, whenever the initiator 205 provides data to be sent to any of the four targets 215, this data is converted into a NoC packet with the destination ID of the decoder switch 305.

Further, in one embodiment, the traffic from the initiator 205 to the decoder switch 305 may travel the same path. For example, regardless which of the four targets 215 is the ultimate destination of the traffic, the traffic may be routed on the same switches (i.e., switch 135A, then switch 135B, then switch 135C, and then switch 135D) to then reach the decoder switch 305. Advantageously, the switches 135A-D do not have to store routing information for the individual targets 215, but just the decoder switch 305. That is, the switches 135A-D may store routing information (e.g., the next hop) for destination ID 0, but not for destination IDs 1-4 since they may never receive packets with those destination IDs. Further, because the traffic from the initiator 205 to the decoder switch 305 may use the same switches 135A-135D, other switches (e.g., switches 135E-135H) may not store routing information for either the decoder switch 305 or the targets 215. The switches 135E-135H may be used by the initiator 205 to reach other targets (not shown) in the NoC 300, or may be used by other initiators. In this manner, instead of the switches 135A-135D storing routing information for four targets, they can simply store the routing information for the decoder switch 305.

Once the decoder switch 305 receives a packet, it can ignore the current destination ID (e.g., destination ID 0) and perform a decode operation using the address in the packet (which is different than the destination ID). In this case, rather than mapping the addresses of the targets 215 to the same destination ID, the decoder switch can map the individual addresses corresponding to the targets 215 to unique target destination IDs (i.e., IDs 1-4). Thus, when the decoder switch 305 forwards a packet, that packet has a target destination ID.

In one embodiment, the switches 135 between the decoder switch 305 and the targets 215 have routing information for the targets 215. Further, the decoder switch 305 can load balance by distributing the traffic to the switches which can also reduce the amount of routing information each switch 135 stores. For instance, the decoder switch 305 may send traffic to the target 215 with destination ID 1 using its upper right port, which then passes through the switches 135 in the upper row to reach the target. In contrast, the decoder switch 305 may send traffic to the target 215 with destination ID 2 using its second most upper port, which then passes through the switches 135 in the second upper row to reach the target. In a similar manner, traffic for the target 215 with destination ID 3 would use the third row from the top to reach the target, and traffic for the target 215 with destination ID 4 would use the bottom row to reach the target.

As a consequence, each of the rows of switches can store routing information only for their respective target. That is, because the decoder switch 305 may send only packets for the upper most target 215 to the upper row of switches 135, these switches 135 do not have to store routing information for the other three targets 215. Thus, the amount of routing information stored in the switches between the decoder switch 305 and the targets can be further reduced.

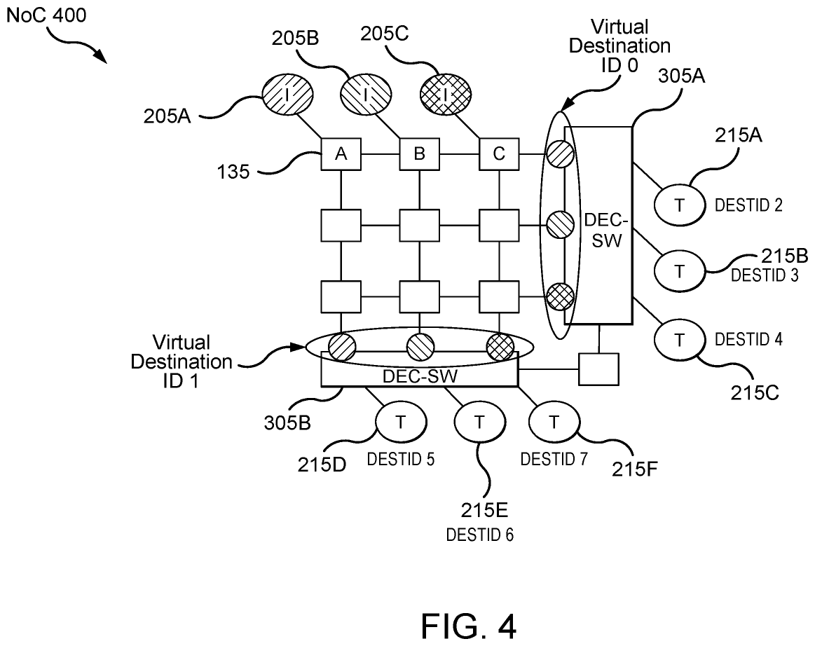

FIG. 4 is a block diagram of a NoC 400 with multiple decoder switches, according to an example. That is, the NoC 400 includes a first decoder switch 305A and a second decoder switch 305B. The NoC 400 also includes three initiators 205A-205C and six targets 215A-215F.

In this example, the initiators 205 can transmit packets to any one of the six targets 215, and as such, the switches 135 are configured with routing information to make this possible. However, access to the targets 215 is controlled by the two decoder switches where decoder switch 305A controls access to targets 215A-215C and decoder switch 305B controls access to targets 215D-215F. Thus, as discussed above, the switches do not have to store routing information for the targets 215 but can only store routing information for reaching the decoder switches 305.

The NoC 400 can be configured such that the route from each of the initiators 205 to each of the decoder switches 305 is predefined, by configuring the routing tables (lookup tables) in the switches 135. For example, when the initiator 205A wants to transmit data to any one of the three targets 215A-215C, this data travels the same path through the switches 135 and is received in the upper left port of the decoder switch 305A. Put differently, in one embodiment, the data being transmitted between the initiator 205A and the decoder switch 305A takes the same path, regardless of the ultimate target 215A-215C. The same may be true for the paths between the initiators 205B and 205C and the decoder switch 305A. That is, the data being transmitted between the initiator 205B and the decoder switch 305A may take the same path each time. In this example, as indicated by the hashing, the decoder switch 305A may receive data from the initiator 205B on its middle port, while the decoder switch 305A may receive data from the initiator 205C on its bottom port. The decoder switch 305A can then use the address in a received NoC packet to determine the target destination ID (e.g., IDs 2-4).

When the initiator 205A wants to transmit data to any one of the three targets 215D-215F, this data travels the same path through the switches 135 and is received in the left port of the decoder switch 305B. Put differently, in one embodiment, the data being transmitted between the initiator 205A and the decoder switch 305B takes the same path, regardless of the ultimate target 215D-215F. The same may be true for the paths between the initiators 205B and 205C and the decoder switch 305B, except the decoder switch 305B receives data from the initiator 2058 at its middle port and receives data from the initiator 205C at its right port. The decoder switch 305B can then use the address in a received NoC packet to determine the target destination ID (e.g., IDs 5-7).

In the NoC 400, the switches 135 may have routing tables to route to only two destination as indicated by the hashing, thereby saving memory relative to a NoC configuration where the switches 135 have routing tables to route from all three initiators 205 to all six targets 215.

The NoC 400 illustrates that each initiator 205 can use its own dedicated port to transmit traffic to the decoder switches 305. However, if there are more initiators that want to access targets than there are ports on the decoder switches 305, then the initiators may share ports. For example, if there are six initiators, then each port of the decoder switches 305 may be dedicated to two of the ports. Further, FIG. 4 illustrates that the targets 215 can be divided up such that access is controlled by different decoder switches 305.

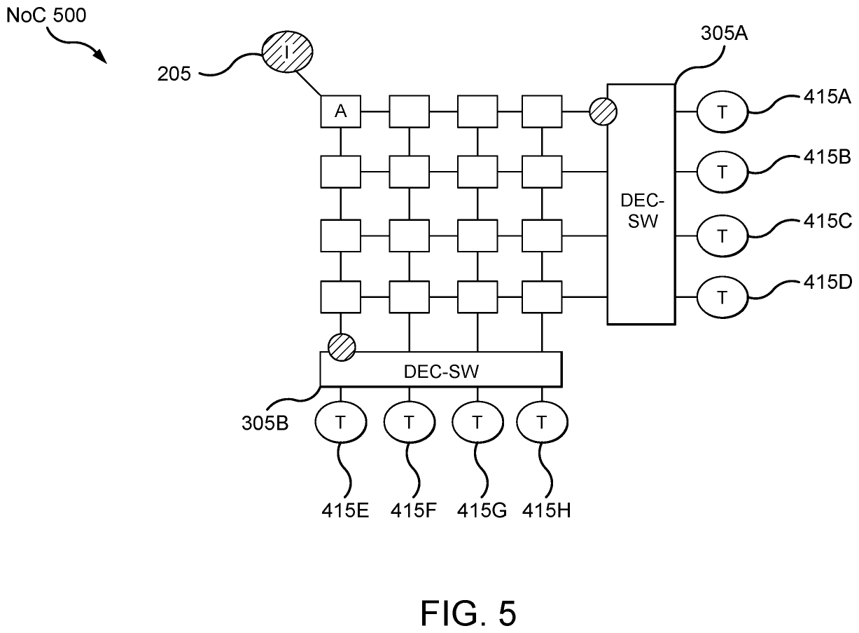

FIG. 5 is a block diagram of a NoC 500 with multiple decoder switches 305, according to an example. FIG. 5 is a simplified use case with a single initiator 205 with two decoder switches 305 at the border of the NoC 500. Here, the initiator 205 connects to Switch A. In one embodiment, Switch A routes only vertically to reach the decoder switch 3058 at the bottom. The decoder switch 305B routes to one of the four targets 415E-415H. Moreover, Switch-A can route horizontally to reach the decoder switch 305A on the right. The decoder switch 305A routes to one of the four targets 415A-415D.

Advantageously. Switch A only has to program two destinations shown by the hashing since the initiator 205 uses the same two ports to communicate with the decoder switches 305A and 305B.

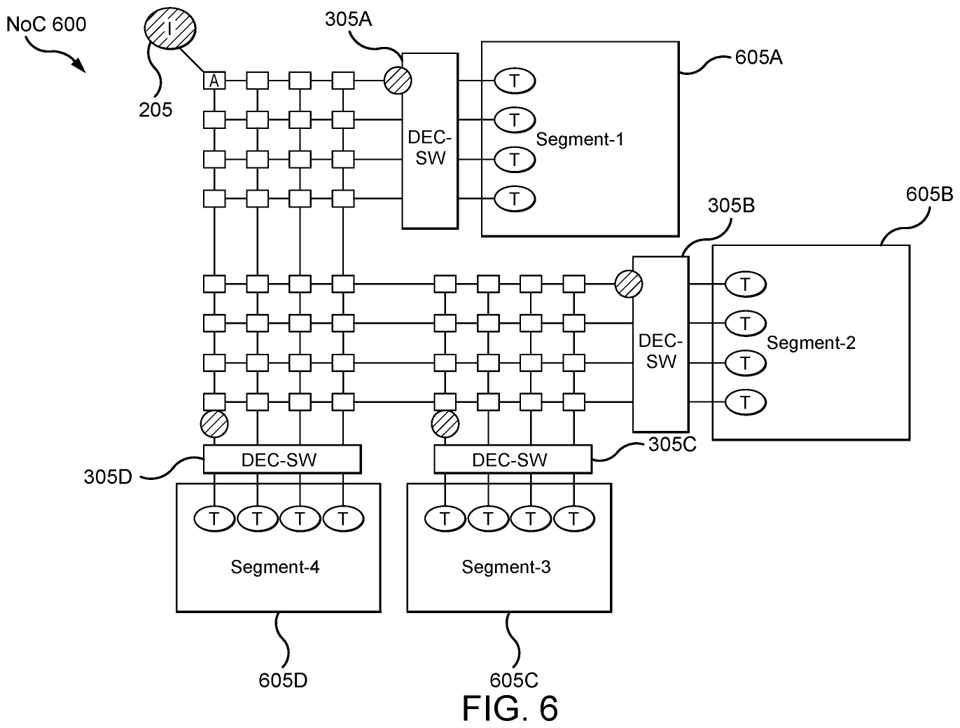

FIG. 6 is a block diagram of a NoC 600 illustrating different segments 605, according to an example. In this case, the segments 605 each contain a set of unique targets, where those targets are accessible using a respective decoder switch 305. That is, the decoder switch 305A controls access to the targets in segment 605A, the decoder switch 305B controls access to the targets in segment 605B, and so forth for segments 605C and 605D.

In this case, Switch A only has to route to the four end-points (one port per each decoder switch 305) as shown. The decoder switches 305 then locally route to the target in their respective segment 605.

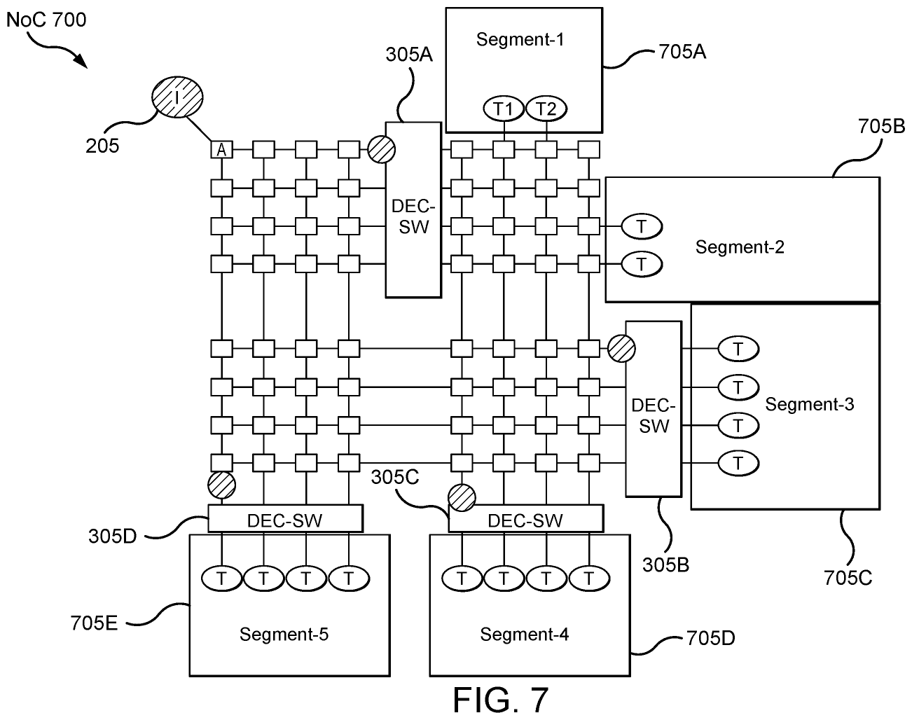

FIG. 7 is a block diagram of a NoC 700 illustrating different segments 705, according to an example. In this example, one decoder switch 305A is placed between two segments (e.g., segments 705A and 705B) as shown. Switch A can use only one destination-ID per segment for segments 705C-705E. Further, to route to segment 705A or 705B, Switch A can route horizontally to the decoder switch 305A which then routes to either segment 705A or 705B. Hence, in all, four destination-IDs are used in Switch A to span 16 targets.

Further, the switches in the bottom two rows of the decoder switch 305 may be used to route to targets in segment 705B, while the switches in the top two rows are used to route to targets in segment 705A. However, in another embodiment, the targets in segments 705A and 705B could be consider as being part of the same segment since access to the targets in those segments are controlled by the decoder switch 305A.

Moreover, FIG. 7 illustrates directly connecting some decoder switches directly to targets (or to egress logic blocks) while other decoder switches can be coupled to additional NoC switches. For example, the decoder switches 305B-305D are coupled on one side to NoC switches and on the other side to targets (or egress logic blocks), while the decoder switch 305A is coupled to NoC switches on both sides. However, in other embodiments, the decoder switches 305 may always be directly connected to the targets or ingress logic blocks, or may always be coupled to NoC switches on both sides.

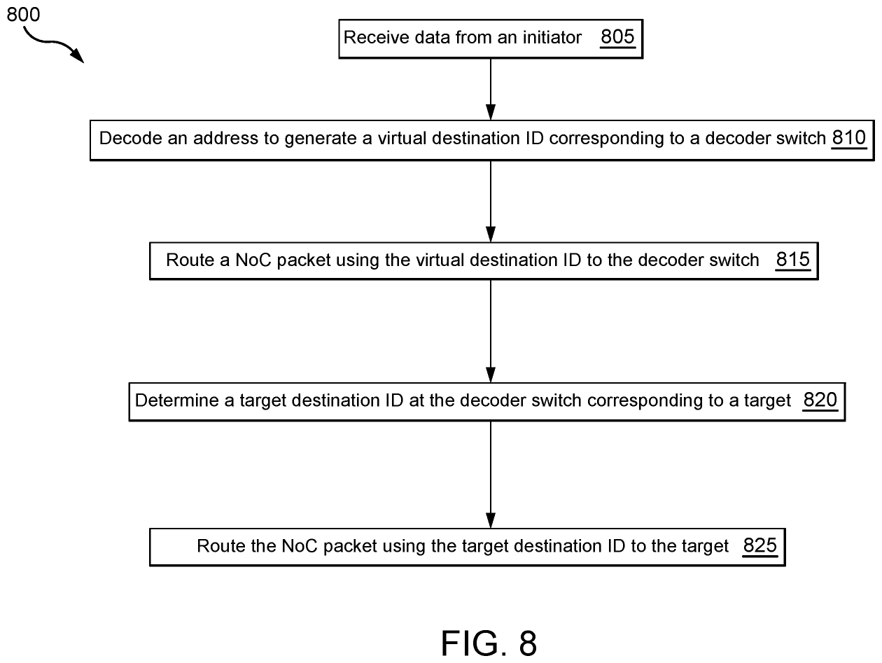

FIG. 8 is a flowchart of a method 800 for routing packets in a NoC using virtual destination IDs, according to an example. At block 805, an ingress logic block receives data from an initiator. In one embodiment, the initiator may be circuitry that is external to the NoC.

At block 810, the ingress logic block decodes an address to generate a virtual destination ID corresponding to a decoder switch. For example, the ingress logic block may map multiple addresses (which may be contiguous or non-contiguous) corresponding to different targets (or destinations) to the same virtual destination ID.

At block 815, the NoC routes a packet using the virtual destination ID through one or more NoC switches until reaching the decoder switch. In one embodiment, the packets generated by the initiator destined for the decoder switch take the same path through the NoC (e.g., through the same switches) to reach the decoder switch. In one embodiment, the NoC switches disposed between the initiator and the decoder switch do not have address decoders.

At block 820, the decoder switch determines a target destination ID at the decoder switch corresponding to the target. In one embodiment, the decoder switch performs this address decoding operation using an address in the NoC packet.

At block 825, the decoder switch routes the NoC packet through a remaining portion of the NoC using the target destination ID to the target. In one embodiment, the decoder switch has multiple ports that are each connected to one target. The decoder switch can use the target destination ID to select which port to use to forward the packet so it arrives at the desired target. In another embodiment, the decoder switch has output ports coupled to more NoC switches (which may not have decoders). These NoC switches can have routing tables configured to recognize and route the packet using the target destination IDs, in contrast to the NoC switches at block 815 which may be configured to recognize only virtual destination IDs corresponding to decoder switches.

### Hierarchical Addressing

In one embodiment, hierarchical address decoding is used to enable the NoC to span many destinations in a scalable fashion. While not required, crossbars can be used with address decoders. The crossbar reduces the number of targets that an initiator has to route to. Referring again to FIG. 4, without a crossbar, each initiator 205 would have to decode all the destinations 215. With the introduction of the crossbars, the initiator 205 would only decode to one virtual destination ID identifying the crossbar (e.g., a crossbar in the decoder switch 305A or 305B). The router will route transactions to one of the four input ports of the crossbar. The crossbar performs the address decoding to determine the destination. In large systems, this mechanism reduces the size of routing tables in the switches considerably. For example, a two-stack high-bandwidth memory (HBM4) system with 128 pseudo channels can be routed with 4-bit route lookup and 16 4×4 crossbars.

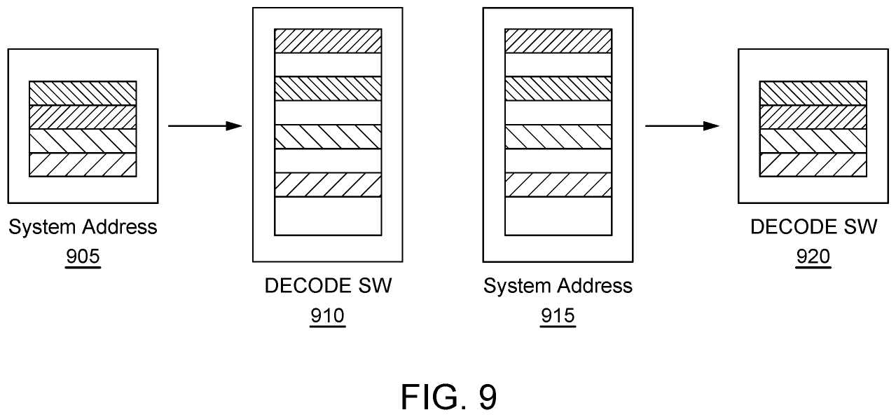

Hierarchical address decoding enables the architecture to provide abstraction between the software visible addressing and the corresponding physical address. By distributing the addressing between the NMUs and the decode-switches, the desired address virtualization can be achieved at a lower cost compared to setting up the virtualization only at the NMU. This is demonstrated in FIG. 9 where a contiguous address space 905 addressed to one decoder switch 910 may be split to different physical addresses and mapped to individual pseudo-channels. Alternatively, disparate address regions 915 from the software's perspective may be mapped to a contiguous space in the physical space of a decoder switch 920.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures Illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit (IC), comprising:
an initiator comprising circuitry; and
a network on chip (NoC) configured to receive data from the initiator to be transmitted to a target, the NoC comprising:
an ingress logic block configured to assign a first virtual destination ID to the data, wherein the first virtual destination ID corresponds to a first decoder switch in the NoC, and
a first NoC switch configured to route the data using the first virtual destination ID to the first decoder switch,
wherein the first decoder switch is configured to decode an address in the data to assign a target destination ID corresponding to the target.

2. The IC of claim 1, wherein a plurality of targets are connected to the first decoder switch, wherein the ingress logic block is configured to assign the same first virtual destination ID to any traffic that is destined for each of the plurality of targets.

3. The IC of claim 2, wherein the NoC transmits data to the plurality of targets only through the first decoder switch, wherein each of the plurality of targets corresponds to a different target destination ID.

4. The IC of claim 2, wherein the first decoder switch is configured to use a different port to route data to each of the plurality of targets.

5. The IC of claim 2, wherein data flows between the initiator and the first decoder switch along a same path in the NoC regardless of which of the plurality of targets is an ultimate destination of the data.

6. The IC of claim 1, wherein the NoC comprises:
a second NoC switch disposed between the first decoder switch and the target, wherein the second NoC switch is configured to route the data using the target destination ID.

7. The IC of claim 6, wherein the second NoC switch does not store routing information corresponding to the first virtual destination ID, and wherein the first NoC switch does not store routing information corresponding to the target destination ID.

8. The IC of claim 1, wherein the NoC further comprises:
a second decoder switch corresponding to a second virtual destination ID, wherein the second decoder switch controls access to a different set of unique targets than the first decoder switch,
wherein the first NoC switch comprises routing information for both the first virtual destination ID and the second virtual destination ID.

9. The IC of claim 8, further comprising:
a second initiator configured to use a third NoC switch to route data to the first decoder switch using the first virtual destination ID and to the second decoder switch using the second virtual destination ID.

10. The IC of claim 9, wherein the first decoder switch receives data from the initiator using a first dedicated port and receives data from the second initiator using a second dedicated port and the second decoder switch receives data from the initiator using a third dedicated port and receives data from the second initiator using a fourth dedicated port.

11. A method, comprising:
receiving, at a NoC, data from an initiator;
decoding an address associated with the data to generate a first virtual destination ID corresponding to a first decoder switch in the NoC;
routing the data through a portion of the NoC using the first virtual destination ID to reach the first decoder switch;
determining a target destination ID at the first decoder switch corresponding to a target of the data; and
routing the data through a remaining portion of the NoC using the target destination ID.

12. The method of claim 11, wherein a plurality of targets are connected to the first decoder switch, the method further comprising:
assigning the same first virtual destination ID to any traffic that is destined for each of the plurality of targets.

13. The method of claim 12, wherein the NoC transmits data to the plurality of targets only through the first decoder switch, wherein each of the plurality of targets corresponds to a different target destination ID.

14. The method of claim 12, further comprising:
transmitting data from the first decoder switch to each of the plurality of targets using a different port on the first decoder switch.

15. The method of claim 12, further comprising:
transmitting data received from the initiator to each of the plurality of targets via the first decoder switch, wherein data flows between the initiator and the first decoder switch along a same path in the NoC regardless of which of the plurality of targets is an ultimate destination of the data.

16. The method of claim 11, wherein routing the data through the remaining portion of the NoC using the target destination ID comprises:
using a NoC switch disposed between the first decoder switch and the target, wherein the NoC switch is configured to route the data using the target destination ID.

17. The method of claim 16, wherein the NoC switch does not store routing information corresponding to the first virtual destination ID.

18. The method of claim 11, further comprising:
receiving, at the NoC, second data from the initiator, the second data corresponding to a second target;
decoding an address associated with the second data to generate a second virtual destination ID corresponding to a second decoder switch in the NoC;
routing the second data through a portion of the NoC using the second virtual destination ID to reach the second decoder switch;
determining a second target destination ID at the second decoder switch corresponding to the second target; and
routing the second data through a remaining portion of the NoC using the second target destination ID,
wherein the second decoder switch controls access to a different set of unique targets than the first decoder switch,
wherein a first NoC switch disposed between the initiator and the first and second decoder switches comprises routing information for both the first virtual destination ID and the second virtual destination ID.

19. The method of claim 18, further comprising:
receiving, at the NoC, third data from a second initiator;
decoding an address associated with the third data to generate either the first or second virtual destination ID; and
routing the third data to either the first decoder switch or the second decoder switch using a second NoC switch comprising routing information for both the first virtual destination ID and the second virtual destination ID,
wherein the first decoder switch receives data from the initiator using a first dedicated port and receives data from the second initiator using a second dedicated port and the second decoder switch receives data from the initiator using a third dedicated port and receives data from the second initiator using a fourth dedicated port.

20. The method of claim 11, further comprising:
performing hierarchical address decoding in the NoC where a contiguous address space addressed to one decoder switch is split to different physical addresses and mapped to individual pseudo-channels.
